(19) United States
(12) Patent Application Publication
(10) Pub. No.: US 2003/0230688 A1
(43) Pub. Date: Dec. 18, 2003

(54) Merchandise display hooks and merchandise suspension arms used therein

(76) Inventors: Kiyohiko Hase, Nagoya-shi (JP); Shizuo Nozaki, Toyoake-shi (JP); Tetsuhito Hasegawa, Nagoya-shi (JP)

Correspondence Address: POSZ & BETHARDS, PLC, 11250 ROGER BACON DRIVE, SUITE 10, RESTON, VA, 20190, US

(21) Appl. No.: 10/461,373

(22) Filed: Jun. 16, 2003

(30) Foreign Application Priority Data
Jun. 17, 2002 (JP) 2002-175680
Aug. 20, 2002 (JP) 2002-238826

(51) Int. Cl. F16B 45/00

(52) U.S. Cl. 248/304

(57) ABSTRACT

A merchandise display hook 20 comprising a downward recess 24 for engagement with a horizontal bar material b, a first groove 32 provided substantially horizontally and substantially orthogonal to the bar material b at the upper surface 21, a first fixing orifice 38 provided substantially perpendicular to the bottom portion of the first groove 32, a second groove 42 provided substantially vertically and substantially orthogonal to the bar material b at the rear surface 23, and a second fixing orifice 48 provided substantially horizontally on the bottom portion of the second groove 42, the hook being substantially entirely composed of a synthetic resin. With such a hook, the number of arms can be easily adjusted with a small number of components, the number of production processes and cost can be reduced, and the merchandise arrangement can be changed rapidly.

### BACKGROUND OF THE INVENTION

1. Field of the Invention

The present invention relates to article display hooks which are employed for displaying a large number of articles such as merchandise enclosed in packages having hangers or through holes at the upper end, and to article suspension arms used therein.

2. Description of the Related Art

A method for suspending articles of merchandise on horizontal metal arms by hangers or through holes provided at the upper end of packages enclosing the articles is widely employed for effectively displaying a large number of articles of merchandise. For example, a merchandise display unit 80 shown in FIG. 16(A) has been used. The display unit 80, as shown in FIG. 16(A) comprises a hook 82 with a substantially ⊃-like cross section which engages by a downward recess 83 with a horizontal bar material 89 composed of an angular steel tube, and a metal arm 84 in which a rear end portion 86 is welded W to the upper surface of the hook 82. A gradually inclined section 85 obtained by bending is positioned at the distal end of arm 84.

A merchandise display unit 81 shown in FIG. 16(B) has also been used. The display unit 81, as shown in FIG. 16(B), comprises a hook 82 identical to the above-described hook and a pair of long and short arms 84, 87 parallel to each other and connected by a vertical section 88 at the rear ends thereof, those arms having inclined sections 85 at the distal ends thereof and being welded W to the hook 82 in the same manner as described above. The hook 82 was obtained by bending a steel sheet, and arms 84, 87 were obtained by bending after chamfering both ends of small-diameter steel rods to obtain a semispherical surface thereon. The upper arm 87 shown in FIG. 16(B), is used for fitting a merchandise display plate (not shown in the figure) on the inclined section 85 and supporting the plate thereon.

The hooks 82 and arms 84, 87 of aforesaid display units 80, 81 are corrosion protected, for example, by chromium plating, over the entire surface after the above-mentioned welding W.

On the other hand, a merchandise display unit 90 has also been used which is designed, as shown in FIGS. 16(C), (c), for being supported on a metal net N fabricated by arranging a plurality of horizontal wires and a plurality of vertical wires in a grid-like fashion and spot welding in the intersection points. This merchandise display unit 90 comprises a base plate 97 comprising at the upper end thereof a pair of hangers 98 and a hanging groove 99 for hanging on a horizontal wire of net N, and an arm 92 fixed to the base plate 97 by welding W the vertical section 94 located at the rear end of the arm. An inclined section 93 is positioned at the distal end of this arm 92.

A merchandise display unit 91 shown in FIG. 16(D) has also been used. This merchandise display unit 91, as shown in FIG. 16(D), comprises a base plate 97 identical to the above-described base plate and a pair of long and short arms 92, 96 welded W to a vertical section 94 at the rear ends thereof, extending horizontally and parallel to each other from the upper part and lower part, and having inclined sections 93, 95 at the distal ends thereof.

The base plates 97 and arms 92, 96 of aforesaid display units 90, 91 are corrosion protected, for example, by chromium plating, over the entire surface after the above-mentioned welding W.

However, the problem associated with merchandise display units 80, 81, 90, 91 was that because they had to be used separately in a configuration comprising one arm 84, 92 and a configuration comprising two arms 84, 87 or 92, 96, the number of structural components required for merchandise display was large and the stock was increased. Another problem was that because chamfering of both ends of steel rods, bending of steel plates or steel rods, welding W and plating were required for each merchandise display unit 80, 81, 90, 91, the number of production processes was large and the cost was increased. Moreover, because the entire structure was from a metal, it had a large weight. Moreover, when the merchandise configuration in the selling space is changed, it is necessary to replace the merchandise display units 80, 81, 90, 91, which requires much labor and efforts. In addition, because all merchandise display units had metal-plated inorganic surfaces, it was difficult to match the marketing concept of each selling space.

### SUMMARY OF THE INVENTION

It is an object of the present invention to resolve the above-described problems inherent to the conventional technology and to provide a merchandise display hook such that the number of arms can be easily adjusted with a small number of components, the number of production processes and cost can be reduced, and the merchandise arrangement can be changed rapidly, the hook also being such that it can be matched easily with the marketing concept of each selling space, and also to provide a merchandise suspension arm which is used in the hook.

In order to attain the above-described object, the present invention was based on a concept of providing a article suspension arm and a hook for supporting the arm separately from each other so that they can be assembled and molding the arm and hook mainly from a synthetic resin.

Thus, the first article display hook (1) in accordance with the present invention comprises a downward recess for engagement with a horizontal bar material, a first groove provided substantially horizontally and substantially orthogonal to the bar material at the upper surface, a first fixing orifice provided substantially perpendicular to the bottom portion of the first groove, a second groove provided substantially vertically and substantially orthogonal to the bar material at the rear surface, and a second fixing orifice provided substantially horizontally on the bottom portion of the second groove, the hook being substantially entirely composed of a synthetic resin.

With such a hook, a first arm having a vertical insertion section at the rear end can be engaged with and supported in the first groove and first fixing groove, and a second arm with a rear end having a substantially ⊃-like shape can be engaged with and supported in the second groove and second fixing groove. Therefore, one or two arms can be selected and supported by using at least one of the first arm and second arm. As a result, the number of components that have to be selling spaced can be decreased and the number of production processes and cost are reduced by comparison with those of the conventional merchandise display units. Moreover, because substantially the entire structure is composed of a synthetic resin, it has a small weight and can be imparted with any color or design. Therefore, by selecting the first arm and second arm, it is possible to change easily the merchandise arrangement or merchandise configuration in the selling space and satisfy the requirements of marketing concept of each selling space. In the present specification, the rear surface indicates the position on the side opposite to the front surface side representing the marketing space where the protruding arm is located.

The first article display hook also includes a hook (2) in which at least one of the first groove and second groove comprises a pair of opening edges that can be elastically deformed and are narrower than the inner diameter of the groove with a substantially round cross section.

With such a hook, the first and second arms can be strongly supported on the hook, the risk of the arms being inadvertently pulled out from the hook or shaken is avoided, and a large number of articles can be displayed while being suspended in a stable state.

Furthermore, the second article display hook (3) in accordance with the present invention comprises a downward recess for engagement with a horizontal bar material, a through hole provided substantially horizontally and substantially orthogonal to the bar material in the vicinity of the upper surface, a vertical hole provided substantially vertically and substantially orthogonal to the bar material in the vicinity of the rear surface and linked to the rear end of the through hole, a vertical hook-shaped recess provided close to the rear end of the through hole and at the upper end of the vertical hole, the hook being substantially entirely composed of a synthetic resin, wherein when a vertical insertion section at the rear end side of a second arm is inserted in the vertical hole, a hook-shaped projection provided on the second arm is fitted into the hook-shaped recess, and when the first arm is inserted into the through hole, a protrusion at the lower end in the hook-shaped projection of the second arm is fitted into an upward notch provided at the rear end of the first arm.

With such a hook, the protrusion at the lower end of the hook-shaped projection provided in the vertical insertion section of the second arm inserted in the vertical hole is fit into the notch provided at the rear end of the first arm inserted into the through hole. At the same time, when the second arm is inserted into the vertical hole, the hook-shaped projection provided in the vertical insertion section at the rear end side of the second arm is fit into the hook-shaped recess. Therefore, the first and second arms can be strongly supported in a state in which they are joined to each other. Further, when only the first arm is supported, a plugging piece that can be inserted into the groove having a protrusion and the above-mentioned hook-shaped projection is used instead of the second arm.

On the other hand, the third article display hook (4) in accordance with the present invention comprises a hook body comprising a hanger for hanging on a horizontal wire comprised in a net in which wires are arranged in a grid-like fashion in the longitudinal and lateral direction, a groove with a substantially ⊃-like shape in the side view thereof which is open at the front surface side below the hanger, depressions positioned on both sides and the front surface side of the groove, and small-diameter portions enclosed in the depressions, the entire hook body having integral configuration and being substantially entirely composed of a synthetic resin, and an arm fixing section comprising integrally a circular arc groove opposing the vertical portion of the groove, an engagement groove having the circular arc groove on the bottom surface, a pair of elastically deformable foot sections extending from both sides of the engagement groove to the rear surface side for individual insertion into the depressions on both sides, and a pair of stopping protrusions formed opposite the distal end of the pair of foot sections for stopping at the rear surface of the small-diameter portion enclosed in the depressions, the arm fixing section being substantially entirely composed of a synthetic resin.

With such a hook, at least one of the two arms having an insertion section at the rear end thereof, or an arm unit comprising two parallel arms and having a ⊃-like shape containing a vertical insertion section at the rear end can be selectively engaged with the ⊃-like groove of hook body and the circular arc groove of the arm fixing section engaging therewith and can be strongly supported without longitudinal or lateral waggles.

As a result, the number of components that have to be selling spaced can be decreased and the number of production processes and cost are reduced by comparison with those of the conventional merchandise display units. Moreover, because substantially the entire structure is composed of a synthetic resin, it has a small weight and can be imparted with any color or design. Therefore, by selecting any of the arms, it is possible to change easily the merchandise arrangement or merchandise configuration in the selling space and satisfy the requirements of marketing concept of each selling space.

The first, second, and third article display hooks also include a hook (5) in which a metal reinforcing plate with a substantially ⊃-like or L-like cross section is provided in a buried condition along the recess, or a metal reinforcing plate is provided in a buried condition along the hanger of the hook body and has a cross section similar in shape to that of the hanger. With such a hook, the vicinity of the recess of the first and second hook for display or the vicinity of the hanger of the third hook for display is reinforced with the metal reinforcing plate provided in a buried condition. For this reason, the appearance of cracks or plastic deformation such as elongation and the like in the vicinity of the recess and hanger can be reliably prevented and a stable article display function can be demonstrated over a long period even when a large number of articles are suspended on one or two arms supported on the hooks.

In addition to the below-described arms, the conventional thin and long steel bars may be used in the first, second, and third article display hooks upon bending and plating.

The article suspension arm (6) in accordance with the present invention has a rear end side thereof supported on a article display hook comprising a downward recess for engagement with a horizontal bar material, or a hanger for hanging on a horizontal wire comprised in a net in which wires are arranged in a grid-like fashion in the longitudinal and lateral direction, the arm comprising a metal rod arranged along the center of the arm, and a synthetic resin covering the periphery of the metal rod, including both ends thereof.

With such a configuration, when a thin long steel wire is cut and bent without chamfering or plating and then set, for example, in an injection molding die and the die is filled with a molten resin, an arm is obtained which is entirely coated with the synthetic resin and has any color or design on the surface.

Therefore, the weight of the article suspension arm itself can be reduced by comparison with the conventional arms, and when the arm is matched with the above-described first and second article display hooks, the selling space itself can be made more colorful and the marketing concept of the selling space can be represented even easier. Further, in the below-described various modes, the arms can comprise a horizontal section, an inclined section at the distal end thereof, and a vertical insertion section at the rear end of the horizontal section, and the hook-shaped projection and the like can be provided integrally, as in the arm supported on the second hook, with the resin covering the periphery of the arm.

The fourth article display hook (7) in accordance with the present invention is composed of a pair of left and right resin semi-units that can be joined together, wherein each of the pair of resin semi-units comprises a downward recess for engagement with a horizontal bar material, a substantially horizontal first groove open at the front surface side at mutually joining surfaces, and a second groove linked to the rear end side of the first groove, formed substantially vertically, and having the upper end thereof open on the upper surface of each resin semi-unit.

With such a configuration, the pair of left and right semi-units can be joined together and supported by hanging the recess thereof on the horizontal bar material in a state in which the horizontal portion of the third article suspension arm with a substantially L-like rear end portion is inserted into the first groove and the rear end portion is inserted into the lower, substantially half portion of the second groove. Furthermore, the pair of left and right semi-units can be also joined together and supported by hanging the recess thereof on the horizontal bar material in a state in which the lower horizontal portion of the fourth article suspension arm, in which the rear end portion has a substantially ⊃-like shape and which has pairs of substantially parallel upper and lower inclined portions and horizontal portions, is inserted into the first groove and the rear end thereof is inserted into the upper, substantially half portion of the second groove. Thus, the third arm comprising one horizontal portion for suspending articles and the fourth arm having two horizontal portions can be selected appropriately and sandwiched in the grooves of the pair of resin semi-units, followed by joining the semi-units together.

For this reason, the number of components that have to be selling spaced can be decreased and the number of production processes and cost are reduced by comparison with those for the conventional merchandise display units. Moreover, because substantially the entire structure is composed of a synthetic resin, it has a small weight and can be imparted with any color or design. Therefore, by selecting the third arm and fourth arm, it is possible to change easily the merchandise arrangement or merchandise configuration in the selling space and satisfy the requirements of marketing concept of each selling space.

In the present specification, the front surface indicates the selling space side where the protruding arm is located.

The fifth article display hook (8) in accordance with the present invention is composed of a pair of left and right resin semi-units that can be joined together, wherein each of the pair of resin semi-units comprises a hanger for hanging on a horizontal wire of a net in which wires are arranged in a grid-like fashion in the longitudinal and lateral direction, and a groove with a substantially ⊃-like shape in the side view thereof which has both ends open in the upper and lower parts of mutually joining surfaces on the front surface side thereof. With such a configuration, the pair of left and right semi-units can be joined together and supported by hanging the hanger thereof on the horizontal wire of the net in a state in which a substantially L-like rear end portion of the third article suspension arm is inserted into the upper horizontal portion and the upper, substantially half of the vertical portion in the ⊃-like groove. Further, the pair of left and right semi-units can be also joined together and supported by hanging the hanger thereof on the horizontal wire of the net in a state in which the substantially ⊃-like rear end portion of the fourth article suspension arm having pairs of substantially parallel upper and lower inclined portions and horizontal portions is inserted into the entire ⊃-like groove.

Thus, because the third and fourth arms can be selected, the number of components that have to be selling spaced can be decreased and the number of production processes and cost are reduced by comparison with those for the conventional merchandise display units. Moreover, because substantially the entire structure is composed of a synthetic resin, it has a small weight and can be imparted with any color or design. Therefore, it is possible to change easily the merchandise arrangement or merchandise configuration in the selling space and satisfy the requirements of marketing concept of each selling space.

Furthermore, the present invention also includes the article display hook (9), wherein the pair of left and right resin semi-units comprise at the mutually joining surfaces thereof depressions or convex sections that can be engaged with each other. With such a configuration, the joining surfaces of both of the pair of resin semi-units can be accurately and easily positioned in a state in which the parts of the arm close to the rear end thereof are sandwiched in the respective grooves of the semi-units. For this reason, the article display hooks in which the parts of the third or fourth article suspension arm close to the rear end thereof are sandwiched between the grooves can be rapidly assembled allowing for easy changes in the merchandise arrangement or merchandise configuration in the selling space.

The above-mentioned depressions and convex sections can be provided in the vicinity of a plurality of through holes for screws or female threaded holes for screwing together the pair of resin semi-units or no less than two thereof can be provided on the joining surfaces in the positions away from the channels of joining screws.

Furthermore, the present invention also includes the article display hook (10), wherein a metal reinforcing plate with a substantially L-like or ⊃-like cross section is provided in a buried condition along the periphery of the recess, or a metal reinforcing plate with a substantially inverted U-like shape is provided in a buried condition along the inner side of the hanger in the pair of left and right resin semi-units. With such a configuration, the vicinity of the recess in the fourth display hook or the vicinity of the hanger in the fifth display hook can be reinforced by the buried metal reinforcing plate. As a result, the appearance of cracks or plastic deformation such as elongation and the like in the vicinity of the recess and hanger can be reliably prevented and a stable article display function can be demonstrated over a long period even when a large number of articles are suspended on the third or fourth article suspension arm supported on the hooks.

In addition to the below-described arms, the conventional thin and long steel bars may be used in the fourth and fifth article display hooks upon bending and plating.

The article suspension arm (11) in accordance with the present invention, which is used in the fourth and fifth article display hooks, comprises a metal rod arranged along the center of the arm composed of an inclined portion at the distal end thereof, a horizontal portion in the medium part, and a rear end portion positioned at the rear end side and having a substantially L-like or ⊃-like cross section in the side view thereof, and a synthetic resin covering the periphery of the metal rod including both ends thereof, wherein the vicinity of the rear end portion is sandwiched between the two grooves of the pair of resin semi-units in the article display hooks. With such a configuration, when a thin long steel wire is cut and bent without chamfering or plating and then set, for example, in an injection molding die and the die is filled with a molten resin, an arm is obtained which is entirely coated with the synthetic resins and has any color or design on the surface. Therefore, the weight of the article suspension arm can be reduced by comparison with the conventional metal arms, and when the arm is matched with the above-described fourth and fifth article display hooks, the selling space itself can be made more colorful and the marketing concept of the selling space can be represented even easier.

Further, the above-described modes include both the configuration with a single inclined portion and a single horizontal portion and the configuration with a pair of upper and lower thereof. Moreover, the term “distal end” used hereinabove refers to the selling space side and the term “rear end side” refers to the rear surface side of the selling space and the rear surface side of the hook.

Furthermore, the term “article” used herein includes not only merchandise or goods but also articles which are being used in house, for example, kitchenware, picture frames or the like. Also, the term “display” used herein includes the act which does not aim at showing for people.

### BRIEF DESCRIPTION OF THE DRAWINGS

FIG. 1(A) is a perspective view of the first merchandise display hook and the arms used therein. FIG. 1(B) is a cross-sectional view along the B-B line in FIG. 1(A). FIG. 1(C) is a different perspective view of the hook;

FIGS. 2(A), (B) are a plan view and vertical cross-sectional view of the hook. FIG. 2(C) is a perspective view illustrating a state in which one arm is supported on the hook. FIG. 2(D) is a schematic view illustrating a state in which the arm is engaged with a groove of the hook. FIG. 2(E) is a vertical cross-sectional view of the hook having the arm supported thereon;

FIGS. 3(A), (B) are perspective views illustrating the states immediately before and immediately after another arm has been additionally supported on the hook. FIG. 3(C) is a vertical cross-sectional view of the hook having two arm supported thereon;

FIGS. 4(A), (B) are a side surface view and a partial expanded view illustrating the first and second arms used in the second merchandise display hook. FIGS. 4(C), (D) are a perspective view and plan view of the hook. FIG. 4(E) is a vertical cross-sectional view illustrating the state in which the hook is used. FIG. 4(F) is a perspective view of a plugging piece used in the hook;

FIGS. 5(A)-(C) are vertical cross-sectional views illustrating the state in which second merchandise display hook is used, following the state shown in FIG. 4(E);

FIGS. 6(A), (B) are perspective views illustrating the third merchandise display hook and the arms used therein;

FIGS. 7(A)-(C) are a perspective view, side view, and front view illustrating the hook body of the third merchandise display hook. FIGS. 7(D), (E) are the end views along the D-D line and E-E line in FIG. 7(C). FIG. 7(F) is a schematic view illustrating the state in which an arm fixing section is engaged with the hook body;

FIGS. 8(A), (B) are the perspective views illustrating the state in which one or two arms are supported on the hook;

FIGS. 9(A), (B) are perspective views illustrating the states immediately before and immediately after the arms of different types have been supported on the hook;

FIGS. 10(A)-(C) are a perspective view, plan view, and bottom view of the first merchandise display hook in accordance with the present invention. FIG. 10(D) is a partial cross-sectional view along the D-D line in FIG. 10(A). FIG. 10(E) is an exploded view in the position shown in FIG. 10(D). FIG. 10(E) is an exploded perspective view of the hook;

FIG. 11(A) is a side view illustrating one resin semi-unit in the hook. FIG. 11(B) is a perspective view of the first merchandise suspension arm. FIG. 11(C) is an expanded cross-sectional view along the C-C line in FIG. 11(B). FIGS. 11(D), (E) are a side view and a perspective view illustrating the state in which the first arm is supported on the hook;

FIG. 12(A) is a perspective view of the second merchandise suspension arm. FIGS. 12(B), (C) are a side view and a perspective view illustrating the state in which the second arm is supported on the hook;

FIGS. 13(A), (B) are perspective views at different angles of the second merchandise display hook in accordance with the present invention. FIG. 13(C) is a side view of one resin semi-unit in the hook. FIG. 13(D) is a partial cross-sectional view along the D-D line in FIG. 13(A). FIG. 13(E) is an exploded view in the position shown in FIG. 13(D);

FIG. 14(A) is an exploded perspective view of the second merchandise display hook. FIGS. 14(B), (C) are a side view and a perspective view illustrating the state in which the first merchandise suspension arm is supported on the hook;

FIGS. 15(A), (B) are a side view and a perspective view illustrating the state in which the second merchandise suspension arm is supported on the second merchandise display hook; and

FIGS. 16(A)-(D) are side views illustrating the conventional merchandise display unit. FIG. 16(c) is a perspective view illustrating the vicinity of the base plate in the merchandise display unit shown in FIG. 16(C).

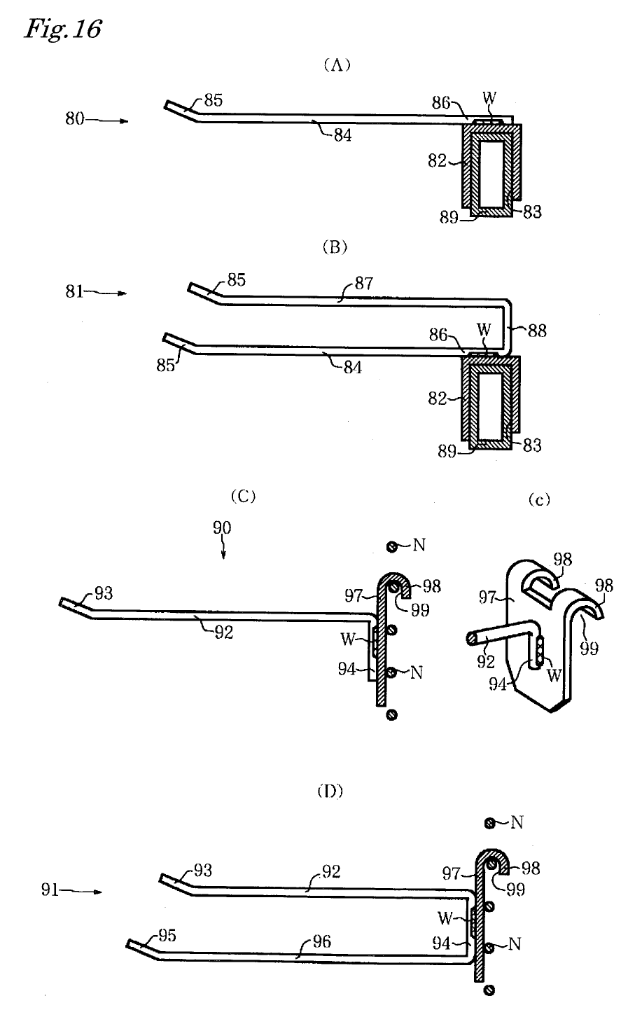

### DESCRIPTION OF THE PREFERRED EMBODIMENTS

The preferred embodiments of the present invention will be described below together with the drawings. The merchandise suspension arm will be hereinbelow sometimes called simply an arm.

[First Embodiment]

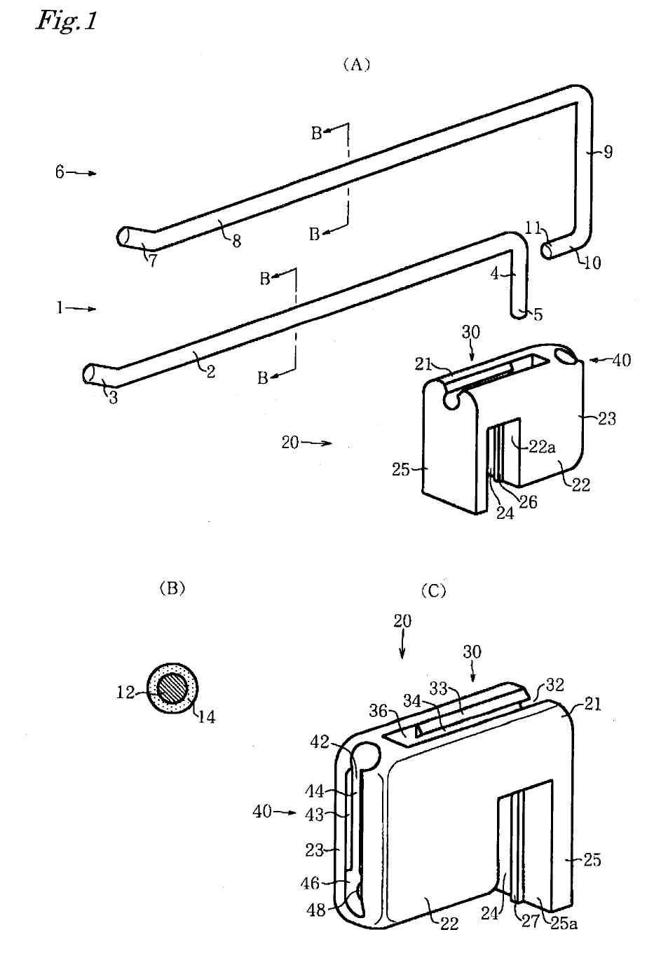

FIG. 1(A) shows a first merchandise display hook 20 and a first arm 1 and a second arm 6 used therein. The first arm 1 comprises an elongated horizontal section 2, an inclined section 3 at the distal end thereof, and a vertical insertion section 4 at the rear end and has a substantially L-like shape. Further, the second arm 6 comprises an elongated horizontal section 8, an inclined section 7 at the distal end thereof, a vertical insertion section 9 at the rear end, and a horizontal insertion section 10 at the lower end thereof. The arms 1, 6, as shown in FIG. 1(B), are composed of a metal rod 12 such as a steel wire positioned along the center and a synthetic resin (for example, polypropylene) 14 covering the periphery and both ends thereof. The entire metal rod 12 can be coated with the synthetic resin 14 by setting the rod, with both ends thereof being cut off, in an injection molding die or the like and filling the mold with a molten resin. Any color or design can be provided on the surface.

The first merchandise display hook 20, as shown in FIGS. 1(A) and 1(C), is in the form of a substantially rectangular solid substantially entirely composed of a synthetic resin (for example, polypropylene) and comprises a downward recess 24 for engagement with a horizontal bar material (not shown in the figures) consisting of an angular steel tube or the like, a first support portion 30 positioned on the side of an upper surface 21, and a second support portion 40 positioned on the side of a rear surface 23.

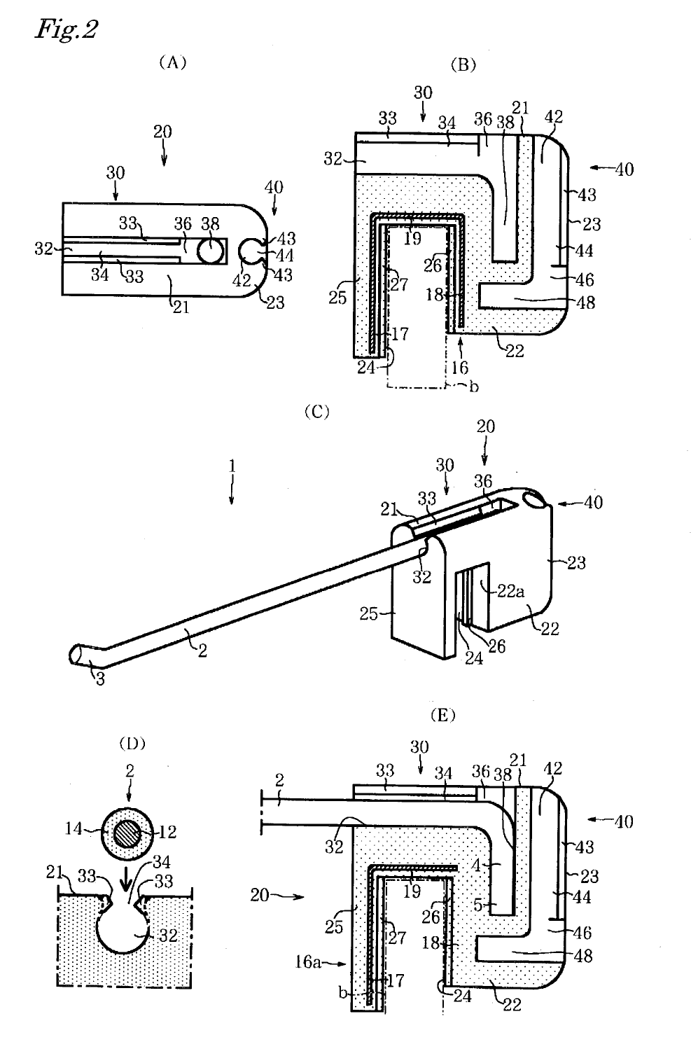

As shown in FIGS. 1(A) and 1(C) and FIG. 2(B), a thin front section 25 and a substantially angular body 22 are positioned on both sides of recess 24. Projections 26, 27 for reinforcement are so as to protrude vertically in the center of inner walls 22a, 25a facing each other inside the recess 24. A metal reinforcing plate 16 with a substantially ⊃-like cross section following the recess 24 is provided in a buried condition, as shown in FIG. 2(B), in the vicinity of recess 24. This metal reinforcing plate 16 is obtained by bending a thin steel sheet or the like and is composed of a pair of long and short vertical sections 17, 18 and a horizontal section 19.

Further, as shown in FIG. 1(C) and FIG. 2(A) the first support portion 30 comprises an open portion 34 in the front-back direction of the upper surface 21 of the hook 20, a pair of opening edges 33 positioned symmetrically on both sides of the open portion 34, a horizontal groove (first groove) 32 positioned on the inner side therebetween, a cavity 36 having no opening edge 33 close to the rear end of the groove 32, and a first fixing orifice 38 sinking vertically at the rear end of the cavity 36.

A pair of opening edges 33, 33 have a substantially >-like cross section, can be deformed elastically, and form an opening portion 34 with a diameter less than the inner diameter of the groove (groove body) 32 which has a substantially round cross section.

The longitudinal direction of the groove 32, as shown in FIG. 2(B), is perpendicular, in a plan view, to the bar material (b) composed, for example, of an angular steel tube engaging with the recess 24 of the hook 20.

Further, as shown in FIG. 1(C) and FIG. 2(B), the second support portion 40 comprises an opening portion 44 extending in the vertical direction in the vicinity of the rear surface 23 of the hook 20, a pair of opening edges 43, 43 positioned on both side of the opening portion 44, a vertical groove (second groove) 42 positioned on the inner side therebetween, a cavity 46 having no opening edge 43 close to the lower end of the groove 42, and a second fixing orifice 48 sinking horizontally at the lower end of the groove. The opening edges 43, 43 also have a substantially >-like cross section and can be deformed elastically. The groove 42 has a substantially round cross section, and the longitudinal direction thereof, as shown in FIG. 2(B), is perpendicular, in a side view, to the bar material (b) engaging with the recess 24.

When only one arm 1 is supported on the merchandise display hook 20, as shown in FIG. 2(C), part of the first arm 1 close to the rear end of horizontal section 2 is inserted downward from the opening portion 34 between the opening edges 33, 33 of the first support portion 30. At this time, as shown by a broken line in FIG. 2(D), the opening edges 33, 33 are elastically deformed so as to come into contract in the lateral direction when the horizontal section 2 of arm 1 is inserted downward. As a result, the horizontal section 2 of arm 1 is tightly engaged with the groove 32 of substantially the same cross section. At the same time, the insertion section 4 of arm 1 is inserted into the first fixing orifice 38, as shown in FIG. 2(E), and the distal end 5 thereof is comes into contact with or close to the bottom surface of this fixing orifice 38.

As a result, as shown in FIG. 2(C), the first arm 1 is strongly supported on the first merchandise display hook 20, without shaking or being pulled out from the first support portion 30, and a large number of articles of merchandise can be suspended and displayed with good stability.

Further, as shown in FIG. 2(E), a metal reinforcement plate 16a with a substantially L-like cross section, which is composed only of a vertical section 17 and a horizontal section 19, may be used instead of the metal reinforcing plate 16.

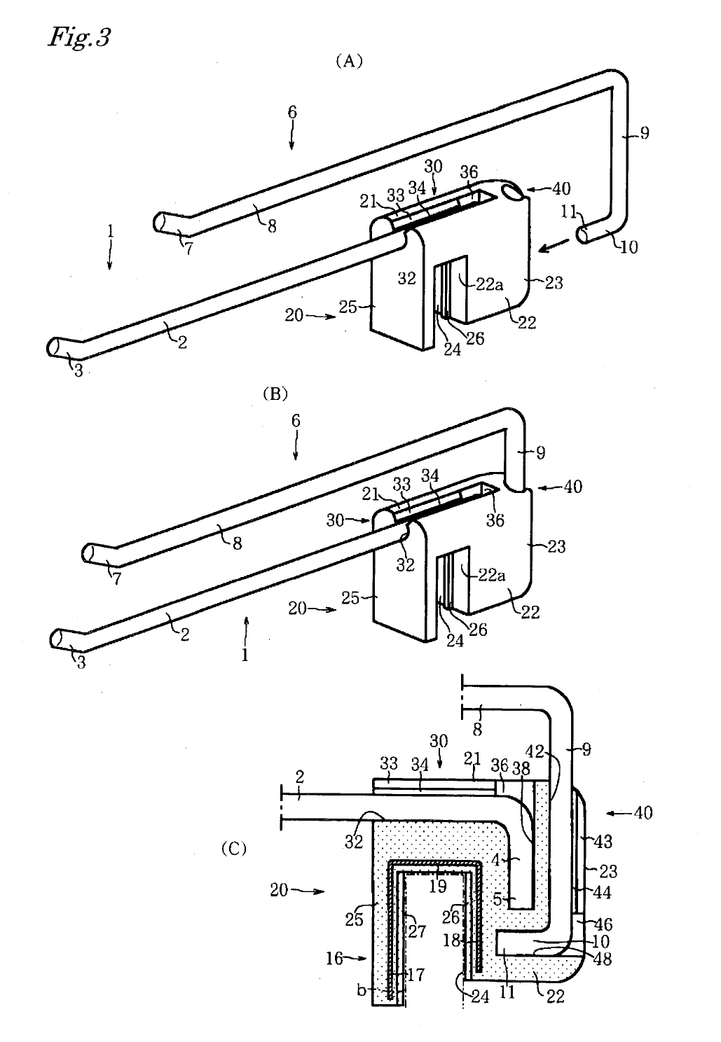

When the second arm 6 is to be additionally supported on the merchandise display hook 20 where the first arm 1 has already been supported, as shown in FIG. 3(A), the vertical insertion section 9 and horizontal insertion section 10 of the second arm 6 are moved horizontally toward the second support portion 40 at the rear surface 23 side of hook 20. As a result, as shown in FIG. 3(C), the lower about half of the insertion section 9 of the second arm 6 passes through the opening portion 44 between the opening edges 43, 43 which are elastically deformed in the same manner as described above and becomes engaged with the groove 42. In addition, the insertion section 10 of arm 6, as shown in FIG. 3(C), is inserted into the second fixing orifice 48, and the distal end 11 thereof is brought in contact with or close to the bottom surface of this fixing orifice 48. As a result, as shown in FIG. 3(B), the second arm 6 is strongly supported on the hook 20, without vertical or horizontal shaking or being pulled out from the second support portion 40. Therefore, a large number of articles of merchandise can be suspended and displayed with good stability.

Therefore, with the first merchandise display hook 20, at least one of the first and second arms 1, 6 can be strongly supported, and a large number of articles of merchandise (not shown in the figure) can be suspended or merchandise display plates can be mounted on the inclined section 7 of arm 6. Furthermore, the surface of the hook 20 and the arms 1, 6 can be of the same color or they can be provided with a uniform design. As a result, articles of merchandise can be easily viewed in the selling space, customers can be made comfortable, and purchasing enthusiasm can be heightened. The conventional thin and long steel bars may be used in the first merchandise display hook 20 upon bending and plating.

[Second Embodiment]

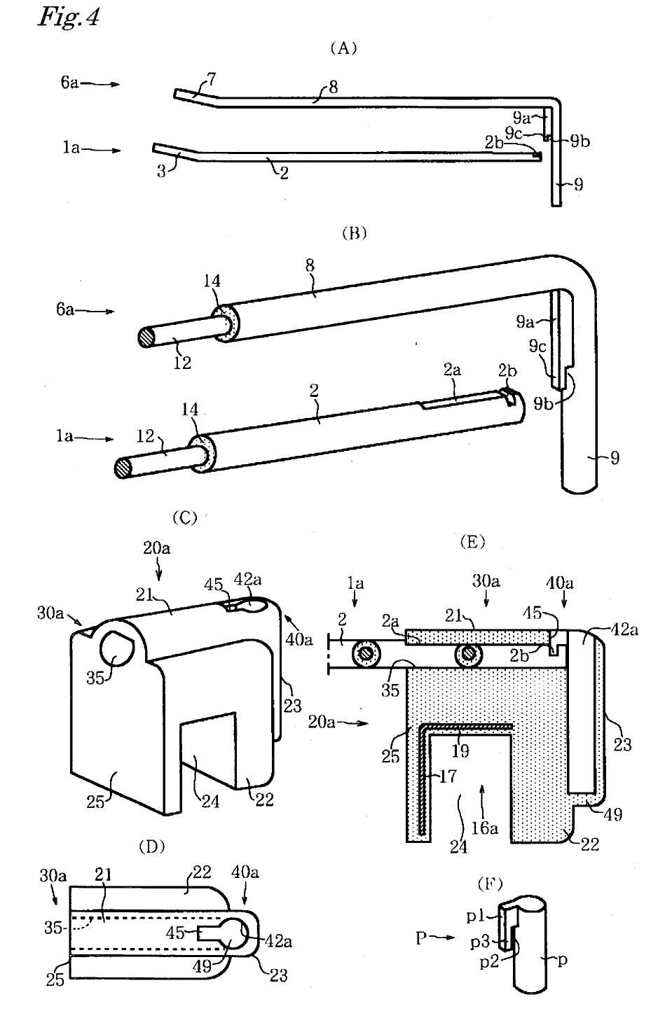

FIG. 4 illustrates the second merchandise display hook 20a.

FIG. 4(A) shows the first arm 1a and second arm 6a used in the second merchandise display hook 20a. The first arm 1a is composed of an elongated horizontal section 2 and an inclined section 3 at the distal end thereof and has a substantially linear shape. The second arm 6a is composed of an elongated horizontal section 8, an inclined section 7 at the distal end thereof, and a vertical insertion section 9 at the rear end thereof.

As shown in FIG. 4(B), the first and second arms 1a, 6a are composed of a metal rod 12 positioned along the center and a synthetic resin 14 covering the periphery and both ends thereof.

As shown in FIG. 4(B), an upward flat plane 2a and a notch 2b provided upward in the vicinity of the rear end are formed close to the rear end of the horizontal section 2 in the first arm 1a. Furthermore, a hook-shaped projection 9a passing down from the inner corner portion formed with the horizontal section 8 is provided in a protruding condition at the insertion section 9 at the rear end of the second arm 6a. A downward small groove 9b and a protrusion 9c are formed at the lower end of the hook-shaped projection. These are entirely formed from the above resin 14.

FIGS. 4(C) and 4(D) are a perspective and a plan view illustrating the second merchandise display hook 20a, respectively. This merchandise display hook 20a, as shown in FIGS. 4(C) and 4(D), is also in the form of a substantially rectangular solid approximately entirely composed of a synthetic resin and comprises a downward recess 24 for engagement with a horizontal bar material (not shown in the figures) consisting of an angular steel tube or the like, a first support portion 30a positioned on the side of an upper surface 21, and a second support portion 40a positioned on the side of a rear surface 23. As shown in FIG. 4(C), a thin front section 25 and a substantially angular body 22 are positioned on both sides of recess 24.

The first support portion 30a comprises a through hole 35 which passes approximately horizontally in the vicinity of upper surface 21 and has an irregular cross section which is substantially round and has a flat surface at the top thereof.

Further, the second support portion 40a, as shown in FIG. 4(D), comprises a vertical hole 42a with a round cross section which passes in the up-down direction in the vicinity of the rear surface 23 of the merchandise display hook 20a and a bottom wall 49 at the lower end of the vertical hole 42a.

As shown in FIG. 4(E), the rear end of the through hole 35 and the upper end of the vertical hole 42a are linked to each other, and as shown in FIG. 4(D), a hook-shaped recess 45 with a ⊃-like cross section is formed close to the vertical hole 42a at the rear end of through hole 35.

The second merchandise display hook 20a is used as follows.

First, as shown in FIG. 4(E), the first arm 1a is inserted horizontally into the through hole 35. At this time, a part close to the rear end of horizontal section 2 where the flat plane 2a has been formed in the first arm 1a is inserted into the through hole 35 and the notch 2b at the rear end thereof is positioned below the hook-shaped recess 45 positioned close to the vertical hole 42a at the rear end of through hole 35.

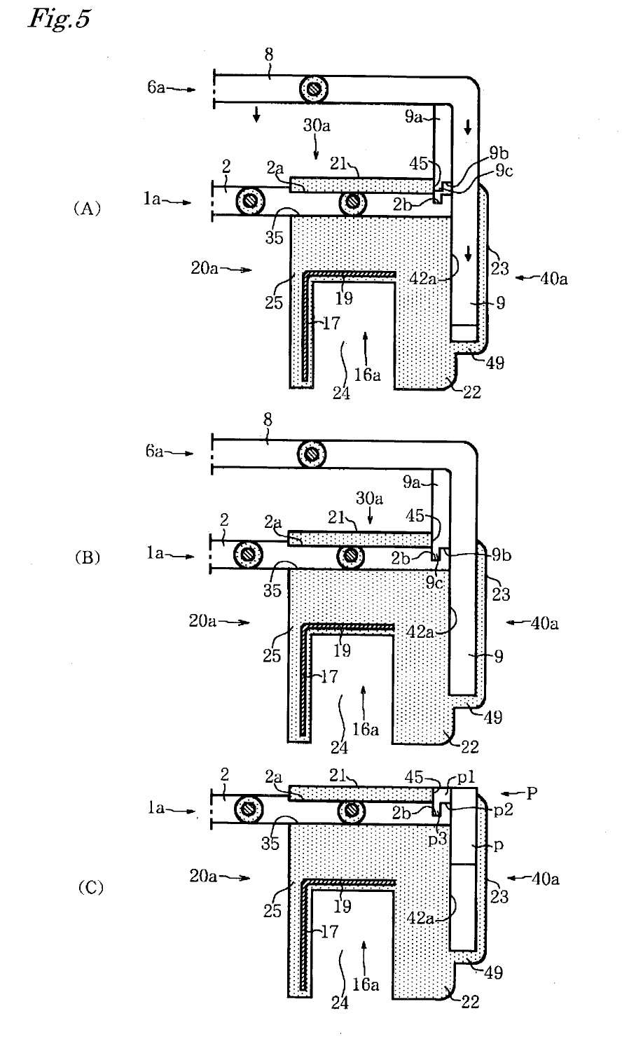

Then, as shown in FIG. 5(A), the vertical insertion section 9 of the second arm 6a is inserted into the vertical hole 42a. At this time, the lower end of the insertion section 9 in the second arm 6a is positioned slightly above the bottom wall 49.

In such a state, the second arm 6a is pushed downward as shown by a vertical arrow in FIG. 5(A). As a result, as shown in FIG. 5(B), the protrusion 9c of the second arm 6a is fit into the notch 2b of the first arm 1a. At the same time, the vertical insertion section 9 of the second arm 6a moves downward into the vertical hole 42a and comes into contact with or close to the bottom wall 49. As a result, as shown in FIG. 5(B), the first and second arms 1a, 6a are joined to each other and strongly supported on the merchandise display hook 20a.

Further, a plugging piece P is used when only the first arm 1a is supported on the merchandise display hook 20a. The plugging piece P is formed from a synthetic resin and comprises, as shown in FIG. 4(F), a cylindrical body p fitting into the vertical hole 42a, a hook-shaped projection p1 protruding to the outside therefrom, and a downward small groove p2 and protrusion p3 positioned at the lower end of the hook-shaped projection p1.

As shown in FIG. 5(C), the first arm 1a is passed into the through hole 35 in the above-described manner, and the protrusion p3 of plugging piece P having the body p thereof inserted into the vertical hole 42a is fit into the notch 2b of the first arm 1a. As a result, as shown in FIG. 5(C), only the first arm 1a can be supported on the merchandise display hook 20a.

The above-described second merchandise display hook 20a can demonstrate functions and produce effects identical to those of the first merchandise display hook 20.

The conventional thin and long steel bars may be also used in the second merchandise display hook 20a upon bending and plating.

[Third Embodiment]

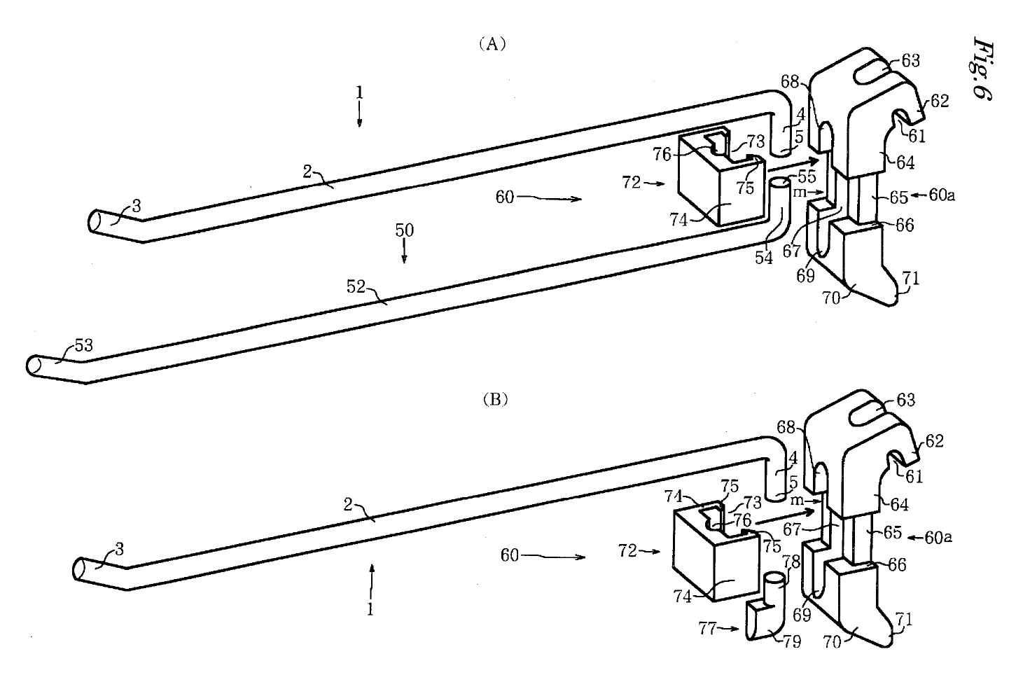

FIG. 6(A) shows the third merchandise display hook 60 and first arm 1 and second arm 50 supported thereon. The second arm 50, as shown in FIG. 6(A), comprises a horizontal section 52 which is slightly longer that the horizontal section 2 of the first arm 1, an inclined section 53 at the distal end thereof, and an insertion section 54 rising vertically from the rear end of the horizontal section 52 and is composed of a metal rod 12 similar to the above-described rod and a synthetic resin 14 covering the periphery.

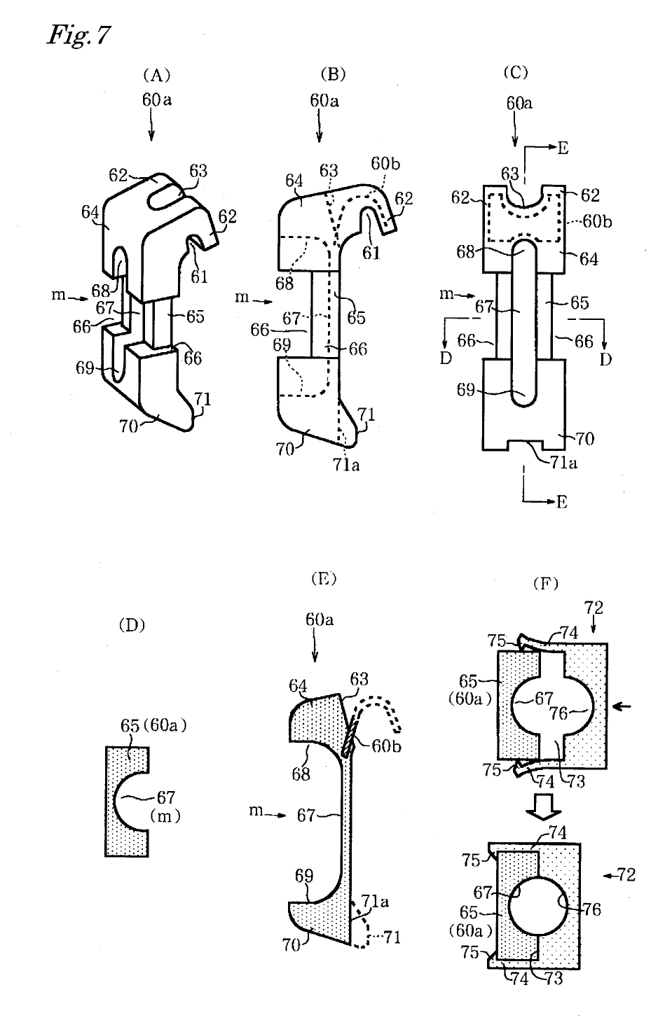

The merchandise display hook 60, as shown in FIG. 6(A) is composed of a hook body 60A and an arm fixing section 72. The hook body 60a, as shown in FIGS. 7(A) through (C), is composed of an upper portion 64, an intermediate small-diameter portion 65, and a lower portion 70. A pair of downward hanging grooves 61, a pair of hangers 62 surrounding the grooves 61, and a depression 63 positioned between the hangers 62 are provided at the rear surface side of the upper portion 64. A horizontal wire N of the below-described net is inserted into the pair of hanging grooves 61. Furthermore, the depression 63 receives the vertical wire n of the below-described net, but also can be omitted.

As shown in FIGS. 7(A) through (D), a small-diameter portion 65 with a substantially rectangular cross section is positioned between the upper part 64 and lower part 70 of hook body 60a, and depressions 66 with a channel-like shape in a plan view and a rectangular shape in a side view are positioned on both sides and the front of the small-diameter portion 65.

As shown in FIGS. 7(A) through (C), a downward contact portion 71 is positioned on the rear surface of the lower part 70 and is in contact with the horizontal wire N of the below-described net. Further, as show in FIGS. 7(C) and 7(E), a vertical depression 71a is positioned in the center on the rear surface side of contact portion 71. This depression 71a also receives the vertical wire n of the net, but also can be omitted.

As shown in FIGS. 7(A) through (C), a groove m open at the front surface side and having a substantially ⊃-like shape in the side view thereof is located from the upper portion 64 to the lower portion 70, in the vicinity of the small-diameter portion 65 on the front surface side of hook body 60a. This groove m is composed of a horizontal groove 68 with a semicircular cross section which is open downward in the upper part 64, a vertical groove (vertical portion) 67 with a semicircular cross section which is connected at a right angle to the rear end of the horizontal groove 68 and positioned on the front surface side of the small-diameter portion 65, and a horizontal groove 69 with a semicircular cross section which is connected at a right angle to the lower end of the vertical groove 67 and is open upward in the lower portion 70.

Further, as shown in FIGS. 7(B), 7(C) and 7(E), a metal reinforcing plate 60b with a substantially inverse U-like cross section along the hanger 62 is provided in a buried condition so as to surround the hanging groove 61 in the hanger 62 of hook body 60a.

On the other hand, the arm fixing section 72 is composed of a synthetic resin similar to the above-described resin and, as shown in FIG. 6(A) and FIG. 7(F), comprises an engagement groove 73 for engagement with the small-diameter portion 65, a pair of leg sections 74 which extend from both ends thereof to the rear surface side and can be deformed elastically, a circular arc groove 76 positioned in the center of the bottom surface of the engagement groove 73, and a pair of stopping protrusions 75 formed opposite each other at the distal ends of leg sections 74. This arm fixing section 72, as shown in FIG. 6(A) and FIG. 7(F), is disposed so that the small-diameter portion 65 of hook body 60a is engaged with the engagement groove 73 and that the circular arc groove 76 faces the vertical groove (vertical portion) 67 of groove m.

As shown in the upper part of FIG. 7(F), if the arm fixing section 72 is inserted along the leftward arrow shown in the same figure, the pair of leg sections 74, 74 are elastically deformed outwardly and move along both side surfaces of the small-diameter portion 65 of hook body 60a. Then, as shown in FIG. 7(F), at the same time as the stopping protrusions 75 of each leg section 74 are stopped on the rear surface of small-diameter portion 65, the circular arc groove 76 together with the vertical groove 67 of groove m form a vertical through hole with a round cross section. As a result, the arm fixing section 72 is engaged with the hook body 60, while being positioned in the depression 66, thereby forming the third merchandise display hook 60.

Thus, as shown in FIG. 6(A), after the rear end portion of the horizontal section 2 and insertion section 4 of the first arm 1 have been inserted into the horizontal groove 68 and vertical groove 67 of groove m, and after the rear end portion of horizontal section 52 and insertion section 54 of the second arm 50 have been inserted into the vertical groove 67 and horizontal groove 69 of groove m, the arm fixing section 72 is engaged in the above-described manner with the hook body 60a.

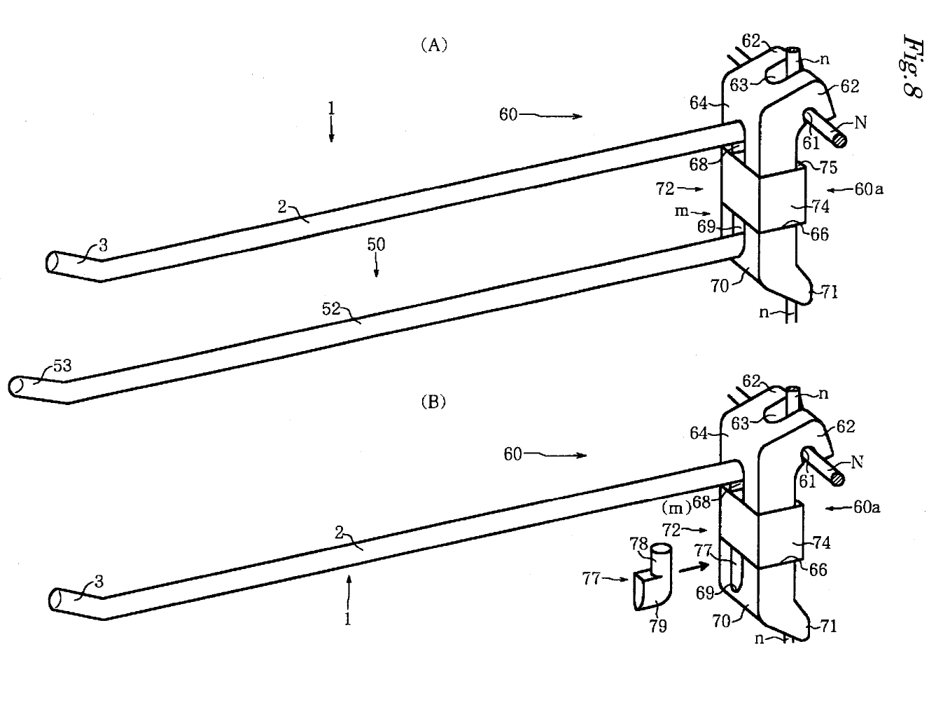

As a result, as shown in FIG. 8(A), the first and second arms 1, 50 are supported, with the horizontal sections 2, 52 thereof being parallel to each other, on the merchandise display hook 60 that was thus formed. Moreover, because the rear end portions of horizontal sections 2, 52 and the insertion sections 4, 54 are surrounded by the vertical groove 67 and horizontal grooves 68, 69 of groove m and by the circular arc groove 76 of arm fixing section 72, the arms 1 and 50 can produce high resistance to waggles in the longitudinal and lateral directions. Therefore, if the above-described merchandise display hook 60 is hooked on a horizontal wire N of a net, then a large number of articles of merchandise can be suspended with good stability on the horizontal sections 2, 52 of the first and second arms 1, 50 or merchandise display plates (not shown in the figures) can be reliably mounted on the inclined section 3 of the first arm 1. Further, as shown in FIG. 8(A), a vertical wire n of the net is inserted in the recesses 63, 71a.

As shown in FIG. 6(B), the arm fixing section 72 can be also engaged with the hook body 60a in the above-described manner after the rear end portion of horizontal section 2 and the insertion section 4 of the first arm 1 have been inserted in the horizontal groove 68 and vertical groove 67 of groove m, and a cover 77 has been inserted in the vertical groove 67 and horizontal groove 69 of groove m. The cover 77 is also composed of the above-described synthetic resin and, as shown in FIG. 6(B), comprises integrally joined to each other a cylindrical insertion section 78 for insertion into the vertical groove 67 of groove m and the circular arc groove 76 of arm fixing section 72 and an R-like section 79 with the lower side having a substantially semicircular cross section for insertion from the lower end of vertical groove 67 into the horizontal groove 69.

As a result, as shown in FIG. 8(B), the first arm 1 is supported on the merchandise display hook 60 in a state in which the horizontal section 2 thereof is horizontal, and because the rear end portion of horizontal section 2 and the insertion section 4 are surrounded by the vertical groove 67 and horizontal groove 68 of groove m and by the circular arc groove 76 of arm fixing section 72, the arm 1 can produce high resistance to waggles in the longitudinal and lateral directions. The horizontal groove 69 of groove m is covered with the cover 77 flush with the front surface of arm fixing section 72.

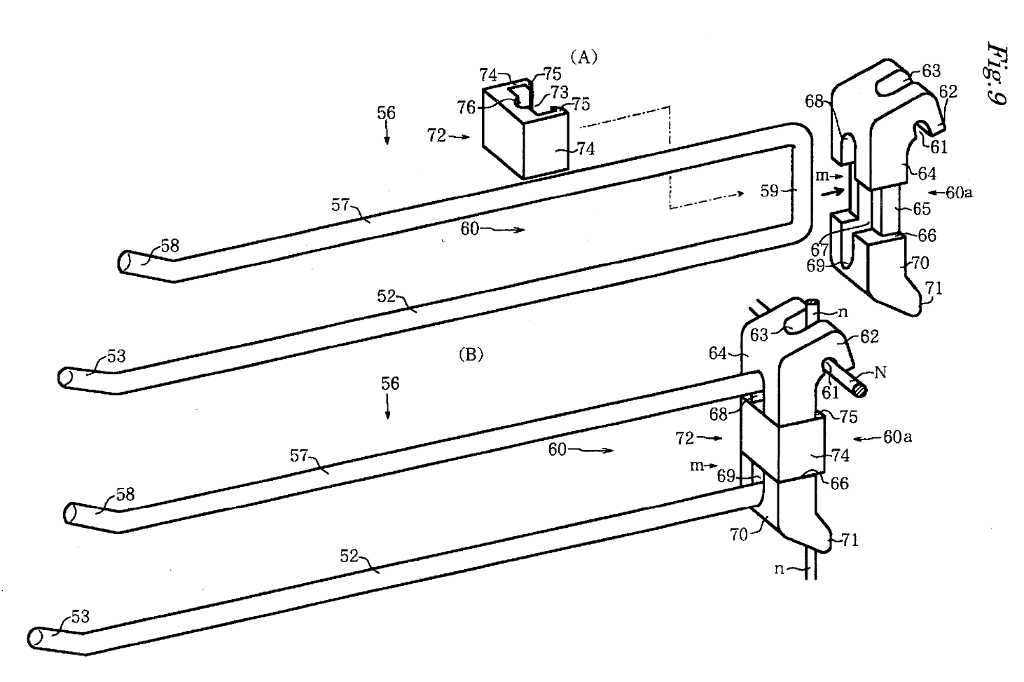

Furthermore, as shown in FIG. 9(A), a third arm 56 with an elongated ⊃-like shape in the side view thereof may be also supported on the third merchandise display hook 60. The third arm 56 is an arm unit composed of a pair of a long and short horizontal sections 52, 57, inclined sections 53, 58 positioned at the distal ends thereof, and a vertical insertion section 59 connecting the rear ends of the horizontal sections 52, 57. The third arm comprises the above-described metal rod 12 as a center covered on the periphery thereof with the synthetic resin 14.

As shown in FIG. 9(A), after the rear end portions of horizontal sections 52, 57 and the insertion section 59 of arm 56 have been inserted into the horizontal grooves 68, 69 and vertical groove 67 of groove m of hook body 60a, the arm fixing section 72 is engaged in the above-described manner with the hook body 60a.

As a result, as shown in FIG. 9(B), the third arm 56 is supported, with the horizontal sections 52, 57 being horizontal, on the merchandise display hook 60 that has been formed. Moreover, because the rear end portions of horizontal sections 52, 57 and the insertion section 59 are surrounded by the circular arc groove 76 of arm fixing section 72 and groove m, the arm 56 can produce high resistance to waggles in the longitudinal and lateral directions. Therefore, if the above-described merchandise display hook 60 is hooked on a horizontal wire N of a net, then a large number of articles of merchandise can be suspended with good stability on the horizontal sections 52, 57 of the third arm 56 or merchandise display plates (not shown in the figures) can be reliably mounted on the inclined section 58 of horizontal section 57.

With the third merchandise display hook 60, which is composed of the above-described hook body 60a and arm fixing section 72, either only the first arm 1 can be supported, or the first and second arms 1, 50 or the third arm 56 can be selectively supported. Therefore, a large number of articles of merchandise can be selected, arranged and suspended, or merchandise display plates can be mounted on the inclined section 3. Furthermore, the surface of the hook 60 and arms 1, 50, 56 can be colored in the same or contrasting colors or can be provided with a uniform design. As a result, merchandise can be easily viewed in the selling space and customers can be made comfortable which will heighten their purchasing enthusiasm.

The conventional thin and long steel bars may be used in the third merchandise display hook 60 upon bending and plating.

(Fourth Embodiment)

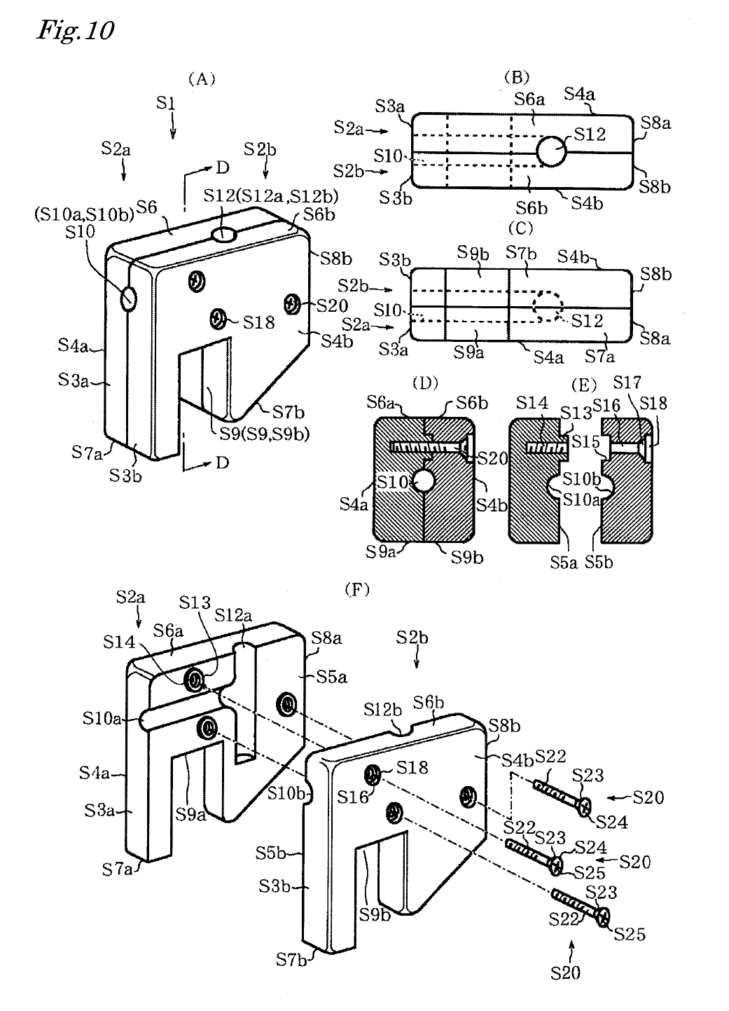

FIG. 10(A) is a perspective view illustrating the fourth merchandise display hook S1. FIGS. 10(B), 10(C), and 10(F) are a plan view, bottom view and exploded perspective view of hook S1.

The merchandise display hook S1, as shown in FIGS. 10(A)-(C), and 10(F), comprises a pair of left and right resin semi-units S2a, S2b which are composed of front surfaces S3a, S3b facing a selling space (not shown in the figures), outer side surfaces S4a, S4b having a substantially trapezoidal shape in the side view thereof, joining surfaces S5a, S5b which are brought into contact with each other, upper surfaces S6a, S6b having a substantially rectangular shape in the plan view thereof, bottom surfaces S7a, S7b, and rear surfaces S8a, S8b. As shown in FIGS. 10(A), 10(C), and 10(F), a downward recess S9 is formed in the bottom surfaces S7a, S7b, this recess being formed by the downward recesses S9a, S9b for engagement with the below-described horizontal bar material and connected in the lateral direction. The resin semi-units S2a, S2b are obtained, for example, by injection molding of a polypropylene resin.

As shown in FIG. 10(F), substantially horizontal first grooves S10a, S10b that have a substantially semicircular cross section with one end thereof being open on the front surfaces S3a, S3b and substantially vertical second grooves S12a, S12b that have a substantially semicircular cross section with one end thereof being open on the upper surfaces S6a, S6b and are linked to the rear end sides of the first grooves S10a, S10b are formed on the joining surfaces S5a, S5b of semi-units S2a, S2b.

The rear ends of the first grooves S10a, S10b are connected at a substantially right angle to the intermediate portion of the second groove S12a, S12b and together form a substantially T-like configuration. As shown in FIGS. 10(A) and 10(C), if the resin semi-units S2a, S2b are brought into surface contact on the joining surfaces S5a, S5b, then the first grooves S10a, S10b form a horizontal first fixing hole S10 with a substantially round cross section, and the second grooves S12a, S12b form a vertical second fixing hole S12 with a substantially round cross section.

The above-described resin semi-units S2a, S2b are screwed together with three screws S20, as shown in FIGS. 10(A) and 10(F). As shown in FIG. 10(F) and presented as an example in FIGS. 10(D) and 10(E), a disk-like convex section S13 and a female threaded hole S14 extending horizontally from the central portion of the convex section toward the outer side surface S4a are formed on the joining surface S5a of resin semi-unit S2a.

Furthermore, a depression S15 for engagement with the convex section S13, a through hole S16 extending horizontally from the central portion of the depression toward the outer side surface S4b, a conical portion S17 and a disk-like step S18 positioned close to the outer side surface S4b are formed in the joining surface S5b of resin semi-unit S2b.

Furthermore, as shown in FIG. 10(F), a screw S20 is composed of a male threaded portion S22, an inclined dish-like portion S23 at the base end thereof, a head S24, and a plus groove S25 provided in the head S24.

As will be described below, at the same time as the first and second merchandise suspension arms are sandwiched between the opposing first grooves S10a, S10b and second grooves S12a, S12b, three convex sections S13 are individually engaged with the depressions S15. In such a state, the male threaded portion S22 of screw S22 is inserted from the outer side surface S4b of resin semi-unit S2b through the step S18, conical portion S17, and through hole S16 of resin semi-unit S2b and then screwed, as shown in the example presented in FIG. 10(D), in the female threaded holes S14 of resin semi-unit S2a. At this time, the dish-like portion S23 and head S24 of screw S20 are positioned inside the conical portion S17 of resin semi-unit S2b. As a result, as shown in FIG. 10(A), a merchandise display hook S1 can be assembled in which an end of the first fixing hole S10 is open on the front surfaces S3a, S3b and the upper end of the second fixing hole S12 is open on the upper surfaces S6a, S6b.

Further, it is also possible to use two or more of screws S20. Furthermore, a configuration is also possible in which two or more of convex sections S13 and depressions S15 are provided in any position of joining surfaces S5a, S5b which is not the position of female threaded hole S14 or through hole S16.

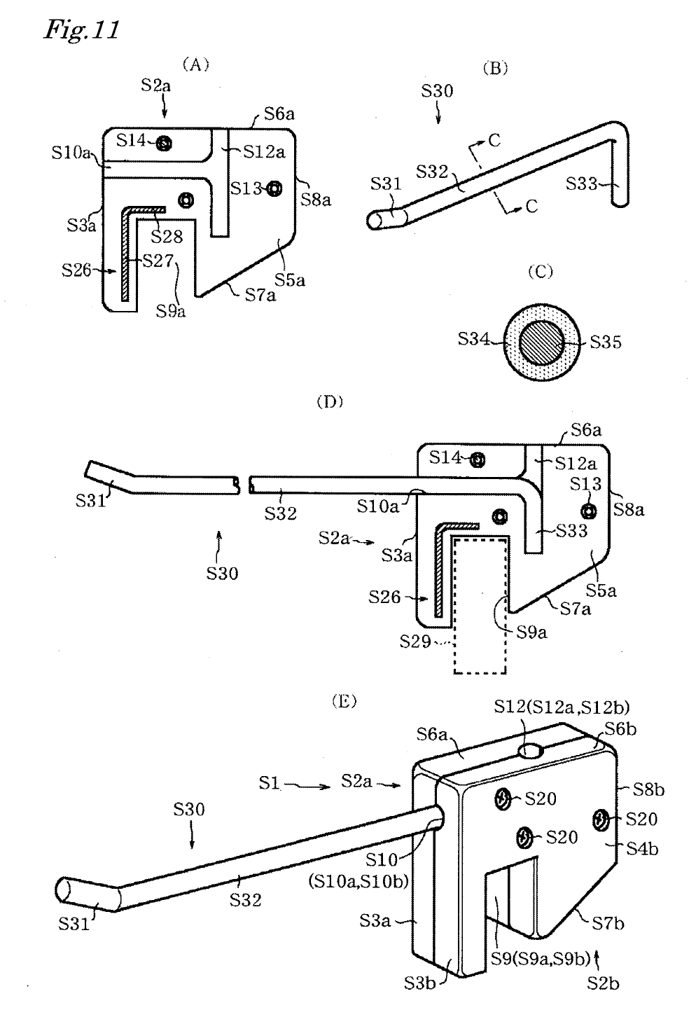

As illustrated by the resin semi-unit S2a shown in FIG. 11(A), a metal reinforcement plate S26 is provided in a buried condition along the periphery close to the front surface S3a in the downward recess S9a. The reinforcement plate S26 was obtained by bending a thin steel sheet, comprises a long vertical section S27 and a short horizontal section S28, and is similarly provided in a buried condition in the same position of resin semi-unit S2b (not shown in the figure). Furthermore, the metal reinforcement plate S26 may have a substantially ⊃-like cross section along the recess S9a. Furthermore, because the resin semi-units S2a, S2b are made from the resin, they can be imparted with any color.

FIG. 11(B) shows the first merchandise suspension arm S30. The arm S30 is composed of an inclined portion S31 at the distal end thereof, a long intermediate horizontal portion S32, and a rear end portion S33 positioned at the rear end of the horizontal portion S32 and having a substantially L-like shape in a side view thereof. As illustrated by the cross-sectional view shown in FIG. 11(C), the arm S30 has a two-layer structure consisting of a metal rod S35 of substantially the similar shape along the central part of the above-described portions and a synthetic resin S34 composed, for example, of polypropylene and coated on the periphery of the metal rod including both end surfaces thereof. More specifically, the outer diameter of the above-described portions is about 5 mm and the outer diameter of metal rod S35 is about 2-3 mm. If the metal rod S35 with both ends thereof in an as-cut state is set into a die of an injection molding apparatus (not shown in the figure) and the die is filled with a molten resin, then the entire rod is coated with the synthetic resin S34 and any color or design can be represented on the surface. The synthetic resin S34 may have a color identical or similar to that of resin semi-units S2a, S2b. Furthermore, when the horizontal portion S32 is fixed, as described below, in the fourth merchandise display hook S1 which is obtained by screwing together the resin semi-units S2a, S2b, it is somewhat raised up from the horizontal line.

Fixing the first merchandise suspension arm S30 to the fourth merchandise display hook S11 will be described hereinbelow based on FIGS. 11(D) and 11(E).

For example, as shown in FIG. 11(D), first, a part of horizontal portion S32 which is close to the rear end thereof and the rear end portion S33 of the merchandise suspension arm S30 are inserted through the entire length of the first groove S10a and the lower about half of the second groove S12a in the resin semi-unit S2a. Then, the joining surface S5b of resin semi-unit S2b is brought into surface contact with the joining surface S5a of resin semi-unit S2a and, at the same time, a plurality of convex sections S13 of the former are positioned by individually engaging with a plurality of depressions S15 of the latter.

In such a state, the male threaded portion S22 of screw S20 is inserted from the outer side surface S4b of resin semi-unit S2b through the step S18, conical portion S17, and through hole S16 of resin semi-unit S2b and screwed thereafter into the female threaded hole S14 of resin semi-unit S2a. At this time, a resin cover (not shown in the figures) may be fit into the step S18 of resin semi-unit S2b to hide the head S24 of screw S20.

As a result, as shown in FIG. 11(E), a part of horizontal portion S32 which is close to the rear end thereof and the rear end portion S33 of the merchandise suspension arm S30 are inserted into and fixed in the lower halves of the first fixing hole S10 and of the second fixing hole S12 formed in the fourth merchandise display hook S1, which is assembled from the resin semi-units S2a, S2b. As shown in FIG. 11(D), a bar material S29 consisting of an angular steel tube or the like is engaged with the recess S9 consisting of recesses S9a, S9b of hook S1 having the arm S30 secured thereto and supports the hook S1 and arm S30. The opening of the second fixing hole S12 may be closed with a disk-like cap (not shown in the figure).

A large number of merchandise packages or hook-shaped portions provided at the upper end of articles of merchandise themselves (not shown in the figures) are hooked and suspended on the horizontal portion S32 of this arm S30. As a result, a large number of articles of merchandise can be displayed while being suspended from the horizontal portion S32 of the first arm S30. Furthermore, a plate-like display member (not shown in the figures) displaying the name, type, or price of the merchandise may be mounted on the inclined portion S31 at the distal end of the arm. Moreover, the marketing concept of the selling space can be clearly demonstrated to the customers by painting the resin semi-units S2a, S2b forming the hook S1 and the synthetic resin S34 forming the surface of arm S30 so as to impart them with identical or similar colors or mutually opposite colors.

It is also possible to bring the joining surface S5a of resin semi-unit S2a into contact with the joining surface S5b and screw them together after the first merchandise suspension arm S30 has been inserted into the first and second grooves S10b, S12b of resin semi-unit S2b.

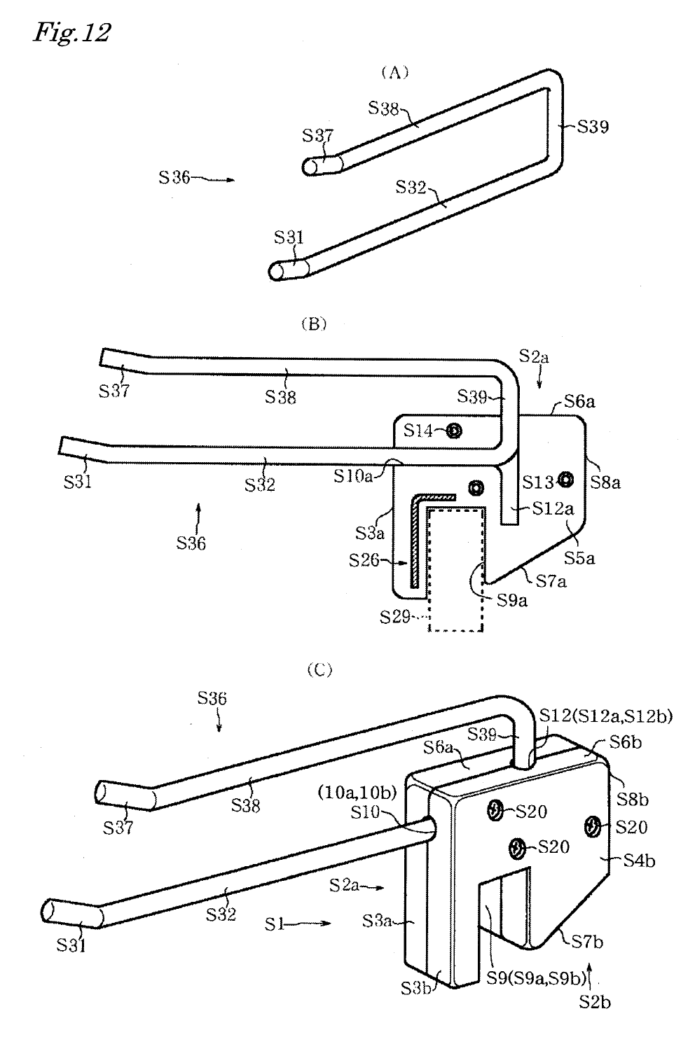

FIG. 12(A) shows the second merchandise suspension arm S36. This arm S36 comprises an inclined portion S31 at the lower distal end, an elongated horizontal portion S32 positioned in the middle, an upper inclined portion S37, an elongated horizontal portion S38 positioned in the middle, and a rear end portion S39 positioned at the rear ends of the horizontal portions S32, S38, connecting them, and producing a substantially ⊃-like shape in the side view of the arm S36. The upper horizontal portion S38 is somewhat shorter than the lower horizontal portion S32, and each of the above-described portions is composed of the above-described metal rod S35 disposed along the center thereof and the above-mentioned synthetic resin S34 covering the periphery of the rod S35. When the horizontal portions S32, S38 are fixed to the fourth merchandise display hook S1 which is obtained by screwing together the resin semi-units S2a, S2b, as described hereinbelow, the horizontal portions S32, S38 are set so as to be slightly raised above the respective horizontal lines.

Fixing the second merchandise suspension arm S36 to the fourth merchandise display hook S1 will be described hereinbelow based on FIGS. 12(B) and 12(C).

For example, as shown in FIG. 12(B), first, a part of the lower horizontal portion S32 which is close to the rear end thereof and the lower about half of the rear end portion S39 of the merchandise suspension arm S36 are inserted into the entire length of the first groove S10a and the upper about half of the second groove S12a in the resin semi-unit S2a.

Then, the joining surface S5b of resin semi-unit S2b is brought into contact with the joining surface S5a of resin semi-unit S2a, and a plurality of convex sections S13 of the former are positioned by individually engaging with a plurality of depressions S15 of the latter. In such a state, in the same manner as described above, the male threaded portion S22 of screw S20 is inserted from the outer side surface S4b of resin semi-unit S2b through the step S18, conical portion S17, and through hole S16 of resin semi-unit S2b and screwed thereafter into the female threaded hole S14 of resin semi-unit S2a.

The joining surface S5a of resin semi-unit S2a may be brought in contact with the joining surface S5b and screwing may be conducted after the second merchandise suspension arm S36 has been inserted into the first and second grooves S10b, S12b of resin semi-unit S2b. Further, a cover (not shown in the figures) may be fit into the step S18 of resin semi-unit S2b to hide the head S24 of screw S20.

As a result, as shown in FIG. 12(C), the fourth merchandize display hook S1 is assembled from the resin semi-units S2a, S2b and the horizontal portion S32 and the rear end portion S39 of the second merchandise suspension arm S36 are inserted into and fixed in the first fixing hole S10 and the lower about half of the second fixing hole S12 formed in the hook S1. As shown in FIG. 12(B), a bar material S29 consisting of an angular steel tube or the like is engaged with the recess S9 of hook S1 having the arm S36 fixed thereto and supports the hook S1 and arm S36.

Then, hook-like portions provided at the upper end of a large number of merchandise packages or the like (not shown in the figures) are hooked and suspended on the lower horizontal portion S32. Furthermore, a plate-like display member (not shown in the figures) displaying the name, type, or price of the merchandize is mounted on the upper inclined portion S37. Alternatively, articles of merchandise of a small height are also suspended from the upper horizontal portion S38. As a result, a large number articles of merchandize can be displayed while being suspended down from the horizontal portions S32, S38 of the second arm S36, and information relating to the merchandise can be provided close to the upper inclined portion S37.

With such fourth merchandise display hook S1, the first merchandise suspension arm S30 or the second merchandise suspension arm S36 is selectively sandwiched between the first grooves S10a, S10b and second grooves S12a, S12b in the resin semi-units S2a, S2b forming the hook S1. As a result, one horizontal portion S32 or two horizontal portions S32, S38 can be selected for hanging and supporting on the horizontal bar material S29.

For this reason, the number of components that have to be selling spaced can be decreased and the number of production processes and cost are reduced by comparison with those for the conventional hooks. Moreover, because substantially the entire resin semi-units S2a, S2b forming the hook S1 are composed of a synthetic resin, they have a small weight and can be arbitrarily colored or put designs. Therefore, by selecting the first arm S30 and second arm S36, it is possible to change easily the merchandise arrangement or merchandise-configuration in the selling space and satisfy the requirements of marketing concept of each selling space.

On the other hand, the weight of the first and second merchandise suspension arms S30, S36 can be reduced by comparison with that of the conventional metal arms, and matching colors of the arms and those of the fourth merchandise display hook S1 makes the selling space itself more colorful and the marketing concept of the selling space can be represented even easier.

In addition to the above-described arms S30, S36, the conventional thin and long steel bars may be used in the fourth merchandise display hook S1 upon bending and plating.

[Fifth Embodiment]

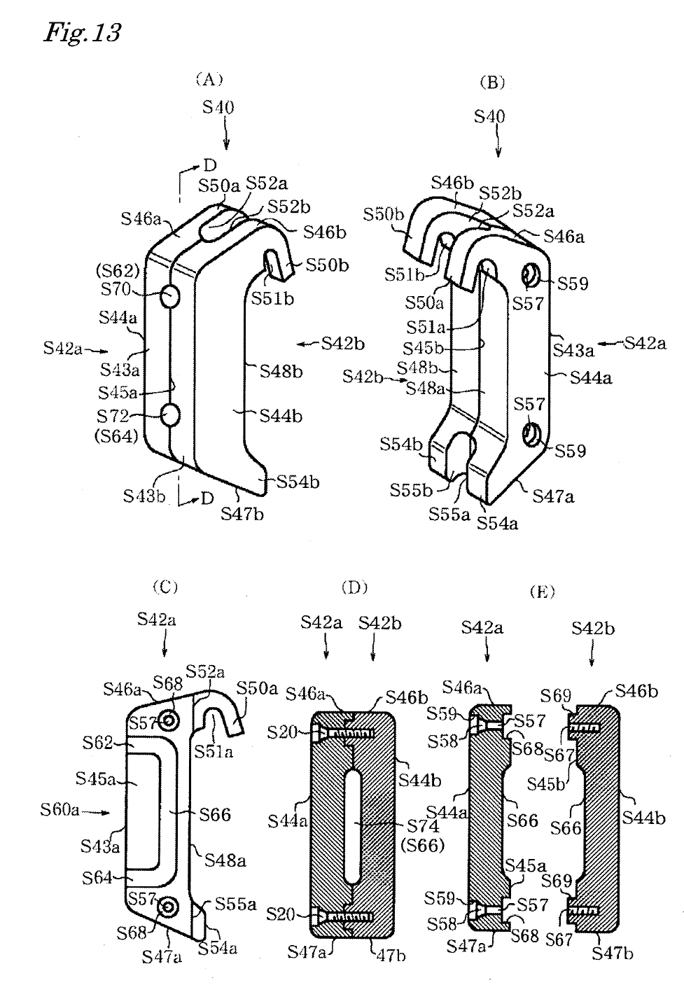

FIG. 13 relates to a fifth merchandise display hook S40. FIGS. 13(A) and 13(B) are the perspective views of the hook at different view angles, FIG. 13(C) is a right side view of a resin semi-unit S42a of hook S40, and FIG. 13(D) is a cross-sectional view along the D-D line in FIG. 13(A).

In the merchandise display hook S40, as shown in FIGS. 13(A)-(D), a pair of resin semi-units S42a, S42b are assembled by screwing them together. The resin semi-units S42a, S42b are obtained by injection molding of a synthetic resin such as polypropylene and are elongated bodies comprising a front surface S43a, S43b, outer side surface S44a, S44b, joining surface S45a, S45b, inclined upper.surface S46a, S46b, inclined bottom surface S47a, S47b, and rear surface S48a, S48b.

At the upper end of resin semi-units S42a, S42b, as shown in FIGS. 13(A)-(C), there are arranged hangers S50a, S50b protruding downward at an angle on the side of rear surfaces S48a, S48b, hanging grooves S51a, S51b located below the hangers S50a, S50b, and longitudinal grooves S52a, S52b positioned therebetween. Further, at the lower end of resin semi-units S42a, S42b, there are positioned contact sections S54a, S54b extending downward at an angle from the bottom surfaces S47a, S47b on the side of rear surfaces S48a, S48b, and longitudinal grooves S55a, S55b positioned therebetween.

Metal reinforcing plates with a substantially inverted U-like shape following the profile of hanging grooves S51a, S51b may be provided in a buried condition on the inner side of hangers S50a, S50b.

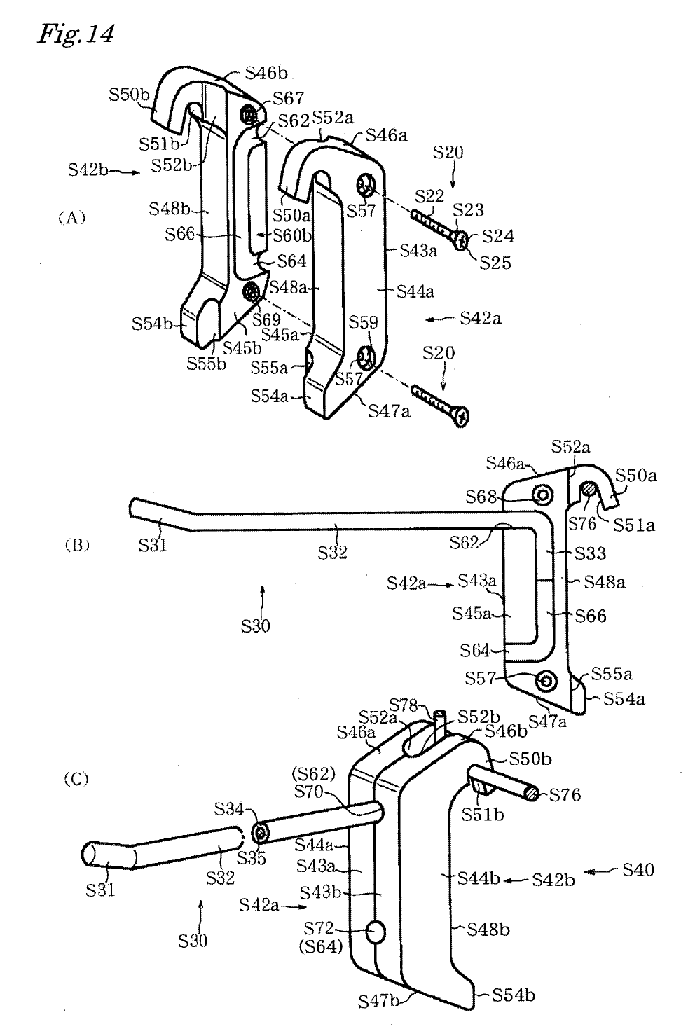

As shown in FIGS. 13(C) and 14(A), grooves S60a, S60b which have a substantially ⊃-like shape in a side view thereof and both ends open on top and bottom of front surfaces S43a, S43b are formed in the joining surfaces S54a, S45b of resin semi-units S42a, S42b. Those grooves S60a, S60b are composed of an upper horizontal portion S62, lower horizontal portion S64, and a vertical portion S66 connecting the rear ends thereof.

Furthermore, as shown in FIGS. 13(B)-(E) and FIG. 14(A), through holes S57, conical portions S58, and steps S59 are formed in the horizontal direction at the upper and lower ends of resin semi-unit S42A, and disk-like depressions S68 are formed in the through holes S57 on the joining surface S45a side. On the other hand, female threaded holes S67 are formed in the horizontal direction at the upper and lower ends of resin semi-unit S42b, and cylindrical convex sections S69 for engagement with the depressions S68 are provided in the protruding condition on the joining surface S45b side at the upper and lower ends of resin semi-unit S42b.

As shown in FIG. 14(A), male threaded portions S22 of screws S20 are inserted from the outer side surface S44a of semi-unit S42a through the steps S59, conical portions S58, and through holes S57, and then screwed, as shown in FIG. 13(D), into the female holes S67 of resin semi-unit S42b. At this time, the dish-like portion S23 and head S24 of screws S20 are positioned inside the conical portions S58 of resin semi-unit S42a. As a result, as shown in FIGS. 13(A), (B), (D), a fifth hook S40 can be assembled in which ends of horizontal fixing holes S70, S72 are open by the grooves S60a, S60b in the upper and lower parts of front surfaces S43a, S43b. Further, as shown in FIG. 13(D), a vertical fixing hole S47 composed of vertical portions S66 of grooves S60a, S60b is positioned inside the hook S40.

Fixing the first merchandise suspension arm S30 to the fifth merchandise display hook S40 will be explained below based on FIGS. 14(B) and 14(C).

For example, as shown in FIG. 14(B), first, a part of horizontal portion S32 which is close to the rear end thereof and the rear end portion S33 of the first merchandise suspension arm S30 are inserted into the upper horizontal portion S62 and the upper about half of vertical portion S66 in the groove S60a of resin semi-unit S42a. Then, the joining surface S45b of resin semi-unit S42b is brought into surface contact with the joining surface S45a of resin semi-unit S42a and, at the same time, the upper and lower convex sections S69 of the latter are positioned by individually engaging with the upper and lower depressions S68 of the former. Then, the male threaded portion S22 of screw S20 is inserted from the outer side surface S44a of resin semi-unit S42a through the step S59, conical portion S58, and through hole S57 and screwed into the female threaded hole S67 of resin semi-unit S42b. At this time, a resin cover (not shown in the figures) may be fit into the step S59 of resin semi-unit S42a to hide the head S24 of screw S20.

As a result, as shown in FIG. 14(C), the horizontal portion S32 and the rear end portion S33 of the first merchandise suspension arm S30 are inserted into and fixed in the fixing hole S70 and the upper about half of fixing hole S74 formed in the fifth merchandise display hook S40, which is assembled from the resin semi-units S42a, S42b. As shown in FIG. 14(C), the hangers S50a, S50b of hook S40 having the arm S30 fixed thereto are hanged and supported on any of horizontal wires S76 of the net obtained by grid-like joining a plurality of horizontal wires S76 and a plurality of vertical wires S78 composed of large-diameter wires. At this time, the vertical wire S78 close to the horizontal wire S76 is inserted in the longitudinal grooves S52a, S52b and longitudinal grooves S55a, S55b of hook S40. The open portion of fixing hole S72 may be closed with a disk-like cap (not shown in the figures).

Hook-like portions provided at the upper end of a large number of merchandise packages or articles of merchandise themselves (not shown in the figures) are hooked and suspended on the horizontal portion S32 of the upper arm S30. As a result, a large number of articles of merchandise can be displayed while being suspended from the horizontal portion S32 of the first arm S30. Furthermore, the above-mentioned display member may be mounted on the inclined portion S31 at the distal end of the arm. Moreover, the marketing concept of the selling space can be clearly demonstrated to the customers by painting the resin semi-units S42a, S42b forming the hook S40 and the synthetic resin S34 forming the surface of arm S30 so as to impart them with identical or similar colors or mutually opposite colors.

It is also possible to bring the joining surface S45a of resin semi-unit S42a into contact with the joining surface S45b and screw them together after the first merchandise suspension arm S30 has been inserted into the groove S60b of resin semi-unit S42b.

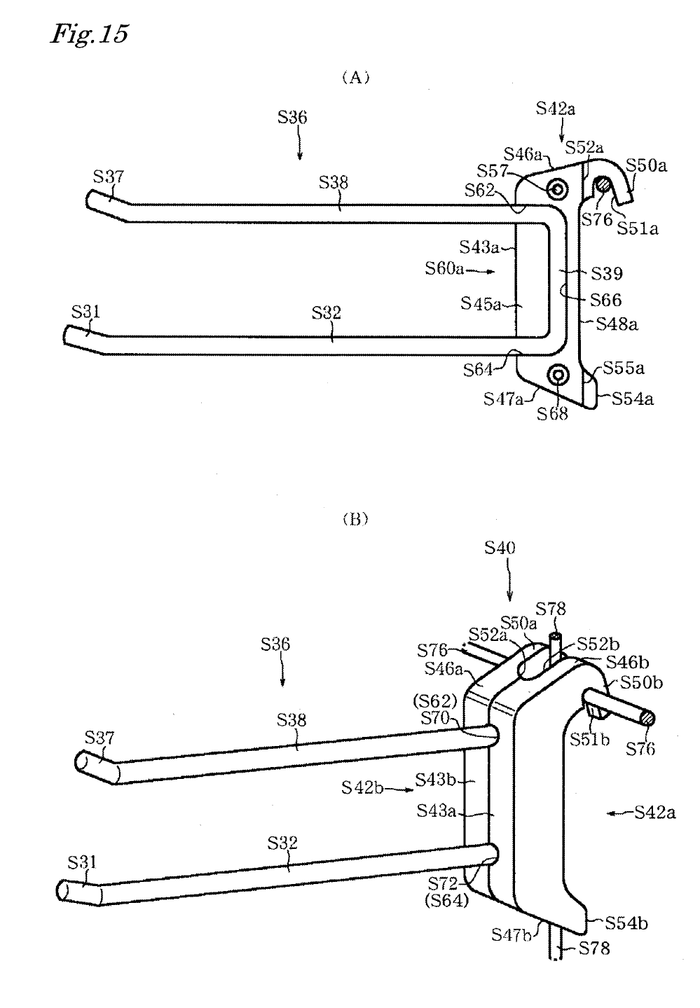

Fixing the second merchandise suspension arm S36 to the fifth merchandise display hook S40 will be described hereinbelow based on FIGS. 15(A) and 15(B).

For example, as shown in FIG. 15(A), first, parts of the horizontal portions S32, S38 which are close to the rear ends thereof and the rear end portion S39 of the second merchandise suspension arm S36 are inserted into the upper horizontal portion S62, lower horizontal portion S64, and vertical portion S66 of the groove S60a of resin semi-unit S42a. Then, the joining surface S45b of resin semi-unit S42b is brought into surface contact with the joining surface S45a of resin semi-unit S42a, and the upper and lower convex sections S69 of the latter are positioned by individually engaging with the upper and lower depressions S68 of the former. The male threaded portion S22 of screw S20 is then inserted from the outer side surface S44a of resin semi-unit S42a into the through hole S57 and the like and screwed into the female threaded hole S67 of resin semi-unit S42b. At this time, a cover may be fit into the step S59 of resin semi-unit S42a.

As a result, as shown in FIG. 15(B), parts of horizontal portions S32, S38 close to the rear ends thereof and the rear end portion S39 of the second merchandise suspension arm S36 are inserted into and fixed in the fixing holes S70, S72 and the fixing hole S74 formed in the fifth merchandise display hook S40 which is assembled from the resin semi-units S42a, S42b. As shown in FIG. 15(B), the hangers S50a, S50b of hook S40 having the arm S36 fixed thereto are hanged and supported on the horizontal wire S76 of the net. At this time, the vertical wire S78 close to the horizontal wire S76 is inserted in the longitudinal grooves S52a, S52b and longitudinal grooves S55a, S55b of hook S40.

Then, hook-shaped portions provided at the upper end of a large number of merchandise packages or the like (not shown in the figures) are hooked and suspended on the lower horizontal portion S32 and a plate-like display member displaying the name or price of the merchandise is mounted on the upper inclined portion S37. Alternatively, articles of merchandise of a small height are also suspended from the upper horizontal portion S38. As a result, a large number of merchandize items can be displayed while being suspended from the horizontal portions S32, S38 of the second arm S36, and information relating to the merchandise can be provided close to the upper inclined portion S37.

With the above-described fifth merchandise display hook S40, the first merchandise suspension arm S30 for or the second merchandise suspension arm S36 is selectively sandwiched and held between the ⊃-like grooves S60a, S60b in the resin semi-units S42a, S42b forming the hook. As a result, one horizontal portion S32 or two horizontal portions S32, S38 can be selected for hanging and supporting on the horizontal wire S76 of the net.

For this reason, the number of components that have to be selling spaced can be decreased and the number of production processes and cost are reduced by comparison with those for the conventional hooks. Moreover, because substantially the entire resin semi-units S42a, S42b forming the hook S40 are composed of a synthetic resin, they have a small weight and can be arbitrarily colored or put designs. Therefore, by selecting the first arm S30 and second arm S36, it is possible to change easily the merchandise arrangement or merchandise configuration in the selling space and satisfy easily the requirements of marketing concept of each selling space.

In addition to the above-described arms S30, S36, the conventional thin and long steel bars may be used in the fifth merchandise display hook S40 upon bending and plating. Moreover, the longitudinal grooves S52a, S52b, S55a, S55b of hook S40 may be omitted.

[Other Embodiments]

The present invention is not limited to the embodiments explained hereinabove.

For example, the grooves 32, 42 or through hole 35 of the first merchandise display hook 20 may be slightly inclined in the vertical or horizontal direction and the fixing holes 38, 48 may be also similarly inclined.

Furthermore, the through hole 35 or vertical hole 42a in the second merchandise display hook 20a may be also slightly inclined in the vertical or horizontal direction.

In the hook body 60a and arm fixing section 72 in the third merchandise display hook 60, two grooves m and two circular arc grooves 76 can be formed on the left and right sides so as to be spread in the widthwise direction, and one or two arms can be selectively supported by the left and right grooves m.

The cross sectional shape of the synthetic resin covering the metal rods of arms is not limited to the round shape and may be semicylindrical with the upper part of the cross section being semicircular and the lower part being quadrangular, or the entire cross section can be polygonal, for example, quadrangular, hexagonal, octagonal, and the like. Accordingly, the cross sectional shapes of grooves 32, m, S10a, S10b, S60a, S60b can be made substantially similar to those cross sectional shapes.

Furthermore, the first grooves S10a, S10b of the fourth and fifth merchandise display hooks S1, S40 or the upper and lower horizontal portions S62, S64 of the grooves S60a, S60b may be slightly inclined with respect to the horizontal direction, and the second grooves S12a, S12b or the vertical portion S66 of the groove S60 may be similarly inclined in the vertical direction.

In addition, the merchandise suspension arms in accordance with the present invention are not limited to the above-described first and second arms S30, S36 and include other configurations, provided that they comprise the inclined portions S31, S37, horizontal portions S32, S38, and end portions S33, S39 and have a two-layer structure composed of synthetic resin S34 and metal rod S35.

Further, the resin semi-units S2a, S2b, S42a, S42b may be joined together by using bolts similar to the screws S20.

What is claimed is:

1. An article display hook comprising:
a downward recess for engagement with a horizontal bar material;
a first groove provided substantially horizontally and substantially orthogonal to said bar material at the upper surface;
a first fixing orifice provided substantially perpendicular to the bottom portion of said first groove;
a second groove provided substantially vertically and substantially orthogonal to said bar material at the rear surface; and
a second fixing orifice provided substantially horizontally on the bottom portion of said second groove, wherein
the hook is substantially entirely composed of a synthetic resin.

2. The article display hook according to claim 1, wherein at least one of said first groove and second groove comprises a pair of opening edges having a substantially round cross section, that are elastically deformable and are narrower than the inner diameter of said groove with.

3. An article display hook comprising:
a downward recess for engagement with a horizontal bar material;
a through hole provided substantially horizontally and substantially orthogonal to said bar material in the vicinity of the upper surface;
a vertical hole provided substantially vertically and substantially orthogonal to said bar material in the vicinity of the rear surface and linked to the rear end of said through hole; and
a vertical hook-shaped recess provided close to the rear end of said through hole and at the upper end of said vertical hole, wherein
the hook is substantially entirely composed of a synthetic resin;
when a vertical insertion section at the rear end side of a second arm is inserted in said vertical hole, a hook-shaped projection provided on the second arm is fitted into said hook-shaped recess; and
when the first arm is inserted into said through hole, a protrusion at the lower end in the hook-shaped projection of said second arm is fitted into an upward notch provided at the rear end of the first arm.

4. An article display hook comprising:
a hook body comprising a hanger for hanging on a horizontal wire comprised in a net in which wires are arranged in a grid-like fashion in the longitudinal and lateral direction, a groove with a substantially ⊃-like shape in the side view thereof which is open at the front surface side below the hanger, depressions positioned on both sides and the front surface side of the groove, and small-diameter portions enclosed in the depressions, the entire of the hook body having integral configuration and being substantially entirely composed of a synthetic resin; and
an arm fixing section comprising integrally a circular arc groove opposing the vertical portion of said groove, an engagement groove having the circular arc groove on the bottom surface, a pair of elastically deformable foot sections extending from both sides of the engagement groove to the rear surface side for individual insertion into said depressions on both sides, and a pair of stopping protrusions formed opposite the distal end of said pair of foot sections for stopping at the rear surface of the small-diameter portion enclosed in said depressions, the arm fixing section being substantially entirely composed of a synthetic resin.

5. The article display hook according to any of claims 1 through 4, wherein a metal reinforcing plate with a substantially ⊃-like or L-like cross section is provided in a buried condition along said recess, or a metal reinforcing plate is provided in a buried condition along the hanger of said hook body and has a cross section similar in shape to that of the hanger.

6. An article suspension arm, having a rear end side thereof supported on an article display hook comprising a downward recess for engagement with a horizontal bar material, or a hanger for hanging on a horizontal wire comprised in a net in which wires are arranged in a grid-like fashion in the longitudinal and lateral direction, wherein
the arm comprises a metal rod arranged along the center of the arm and a synthetic resin covering the periphery of the metal rod including both ends thereof.

7. An article display hook composed of a pair of left and right resin semi-units that can be joined together, wherein
each of said pair of resin semi-units comprises a downward recess for engagement with a horizontal bar material, a substantially horizontal first groove open at the front surface side at mutually joining surfaces, and
a second groove linked to the rear end side of said first groove, formed substantially vertically, and having the upper end thereof open on the upper surface of each resin semi-unit.

8. An article display hook composed of a pair of left and right resin semi-units that can be joined together, wherein
each of said pair of resin semi-units comprises a hanger for hanging on a horizontal wire of a net in which wires are arranged in a grid-like fashion in the longitudinal and lateral direction, and
a groove with a substantially ⊃-like shape in the side view thereof which has both ends open in the upper and lower parts of mutually joining surfaces on the front surface side thereof.

9. The article display hook according to claim 7 or 8, wherein said pair of left and right resin semi-units comprise at the mutually joining surfaces thereof depressions or convex sections that can be engaged with each other.

10. The article display hook according to claim 7 or 8, wherein a metal reinforcing plate with a substantially L-like or ⊃-like cross section is provided in a buried condition along the periphery of said recess, or a metal reinforcing plate with a substantially inverted U-like shape is provided in a buried condition along the inner side of said hanger in said pair of left and right resin semi-units.

11. An article suspension arm, which is used in the article display hook according to claim 7 or 8, wherein the arm comprises a metal rod arranged along the center of the arm composed of an inclined portion at the distal end, a horizontal portion in the medium part, and a rear end portion positioned at the rear end side and having a substantially L-like or ⊃-like cross section in the side view thereof, and a synthetic resin covering the periphery of the metal rod including both ends thereof; and
the vicinity of said rear end portion is sandwiched between the two grooves of the pair of resin semi-units in said article display hooks.
